(19) United States
(12) Patent Application Publication
(10) Pub. No.: US 2017/0159878 A1
(43) Pub. Date: Jun. 8, 2017

(54) Go anywhere clip on paper towel dispenser

(71) Applicant: Dennis Jay Lewis, Las Vegas, NV (US)

(72) Inventor: Dennis Jay Lewis, Las Vegas, NV (US)

(21) Appl. No.: 14/946,222

(22) Filed: Nov. 19, 2015

(51) Int. Cl. F16M 13/02; A47K 10/22

(52) U.S. Cl. CPC F16M 13/022; A47K 10/22

(57) ABSTRACT

Go anywhere clip on paper towel dispenser is disclosed. This device is portable and can be clipped anywhere. Device is used to dispense paper towels from a role to clean up any kind of a mess or spill.

### BACKROUND OF THE INVENTION

### Problem Solved

Cleaning up

Cannot be moved or wind blows over

Is portable can be clipped any where

### DETAILED DESCRIPTION OF THE INVENTION

As stated above, cleaning up. The invention claimed here solves this problem.

Provides paper towels for cleaning

The claimed invention differs from what currently exists. Can be moved and clipped on any

Where

This invention is an improvement on what currently exists. Can be moved and clipped on any

Where

Most not portable

This device is portable can be clipped any where

### THE VERSION OF THE INVENTION DISCUSSED HERE INCLUDES

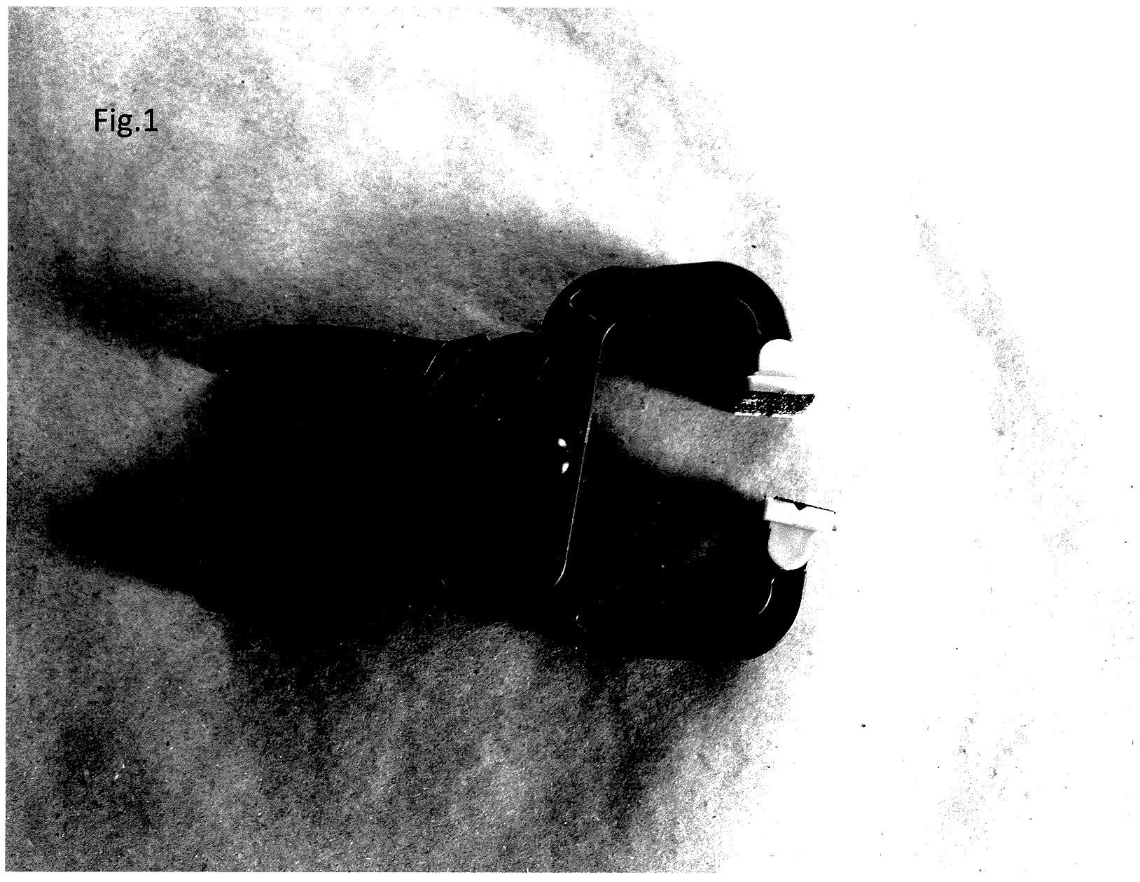

FIG. 1 6 inch clamp

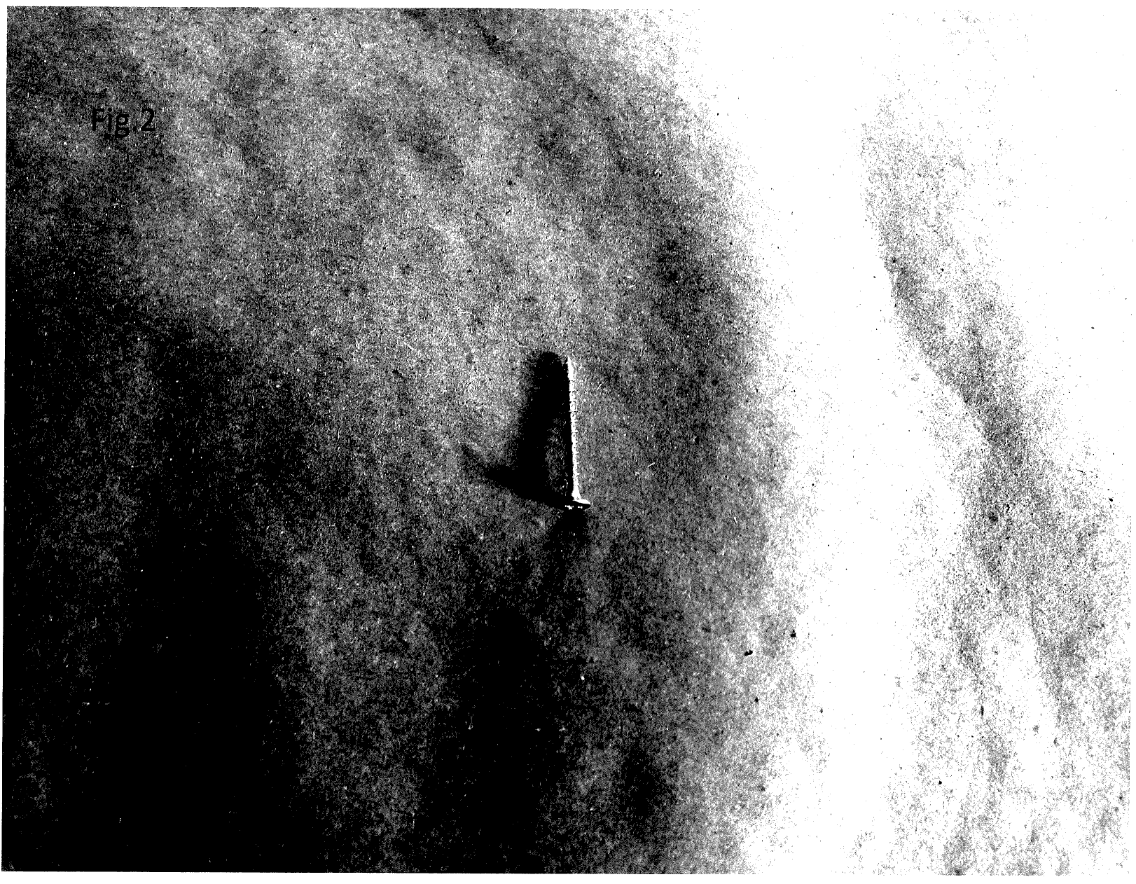

FIG. 2 1 & ½ inch screw

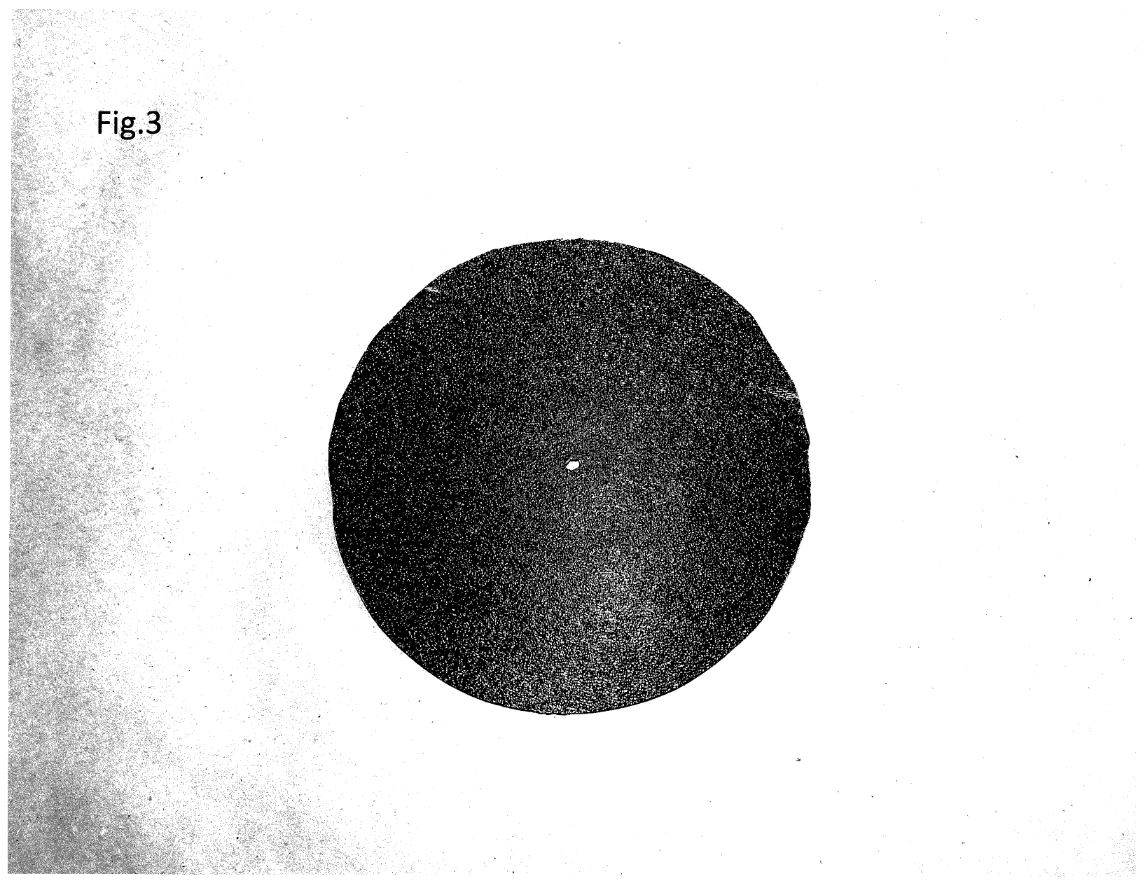

FIG. 3 6 inch diameter disk with 3/16^{th} inch hole in middle

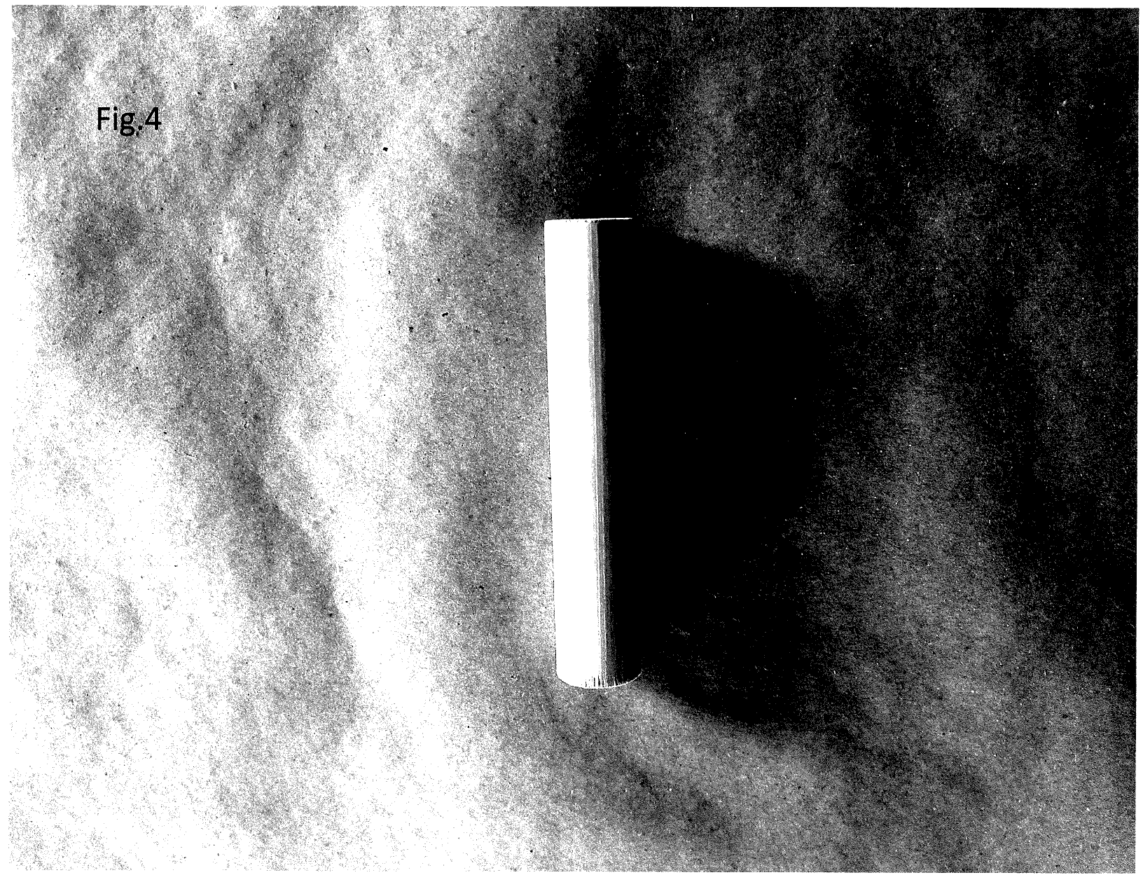

FIG. 4 1 inch×6 inch dowel

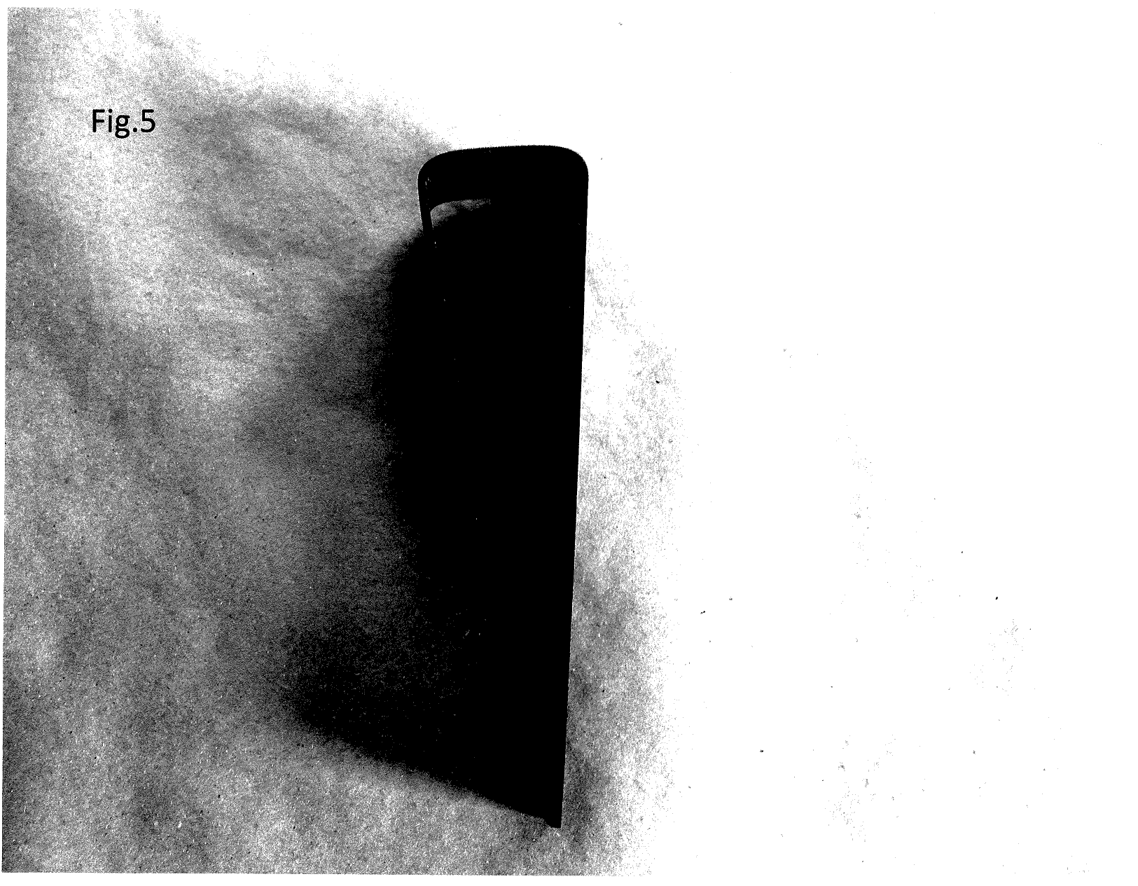

FIG. 5 1 & ½ inch wide plastic clip 18 inch long bent at 10 inches bent at 2 inches bent at 6 Inches

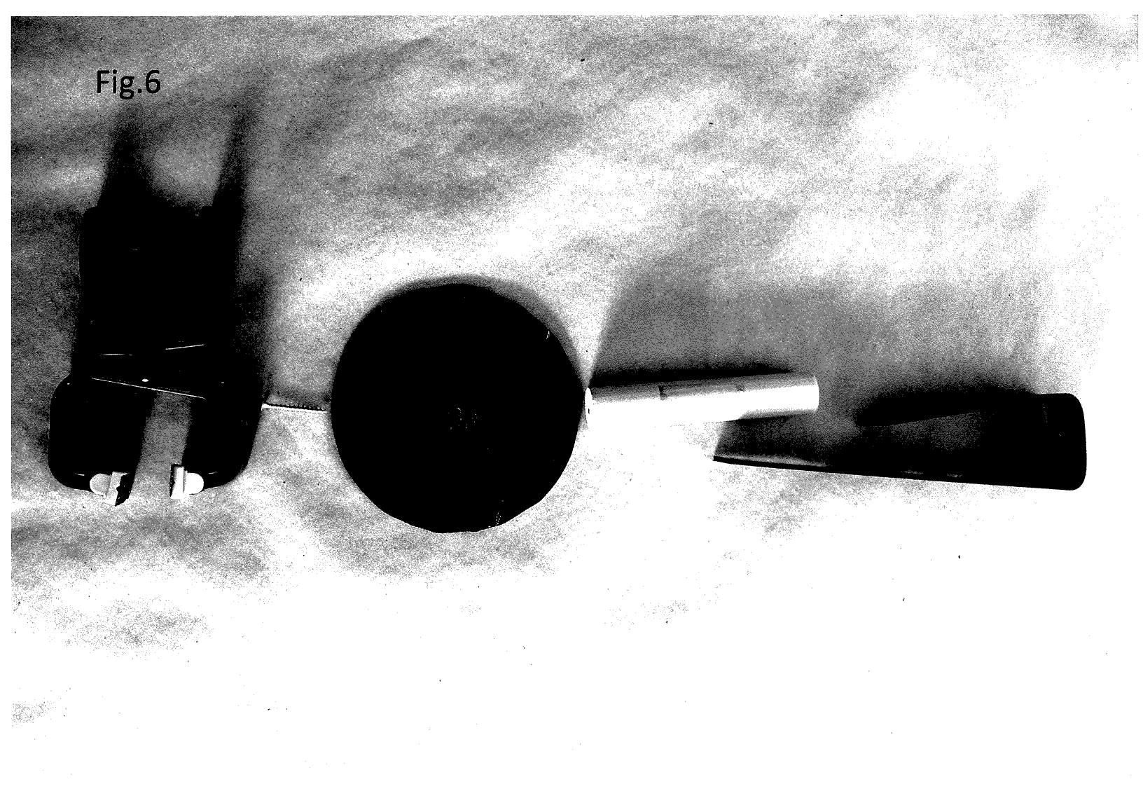

FIG. 6=FIG. 1+FIG. 2+FIG. 3+FIG. 4 +FIG. 5

Put FIG. 2 into FIG. 1 then FIG. 2. Threw center hole in FIG. 3. Disk

FIG. 2. Screw into end of dowel FIG. 4.

FIG. 5 Slides into paper towel tub

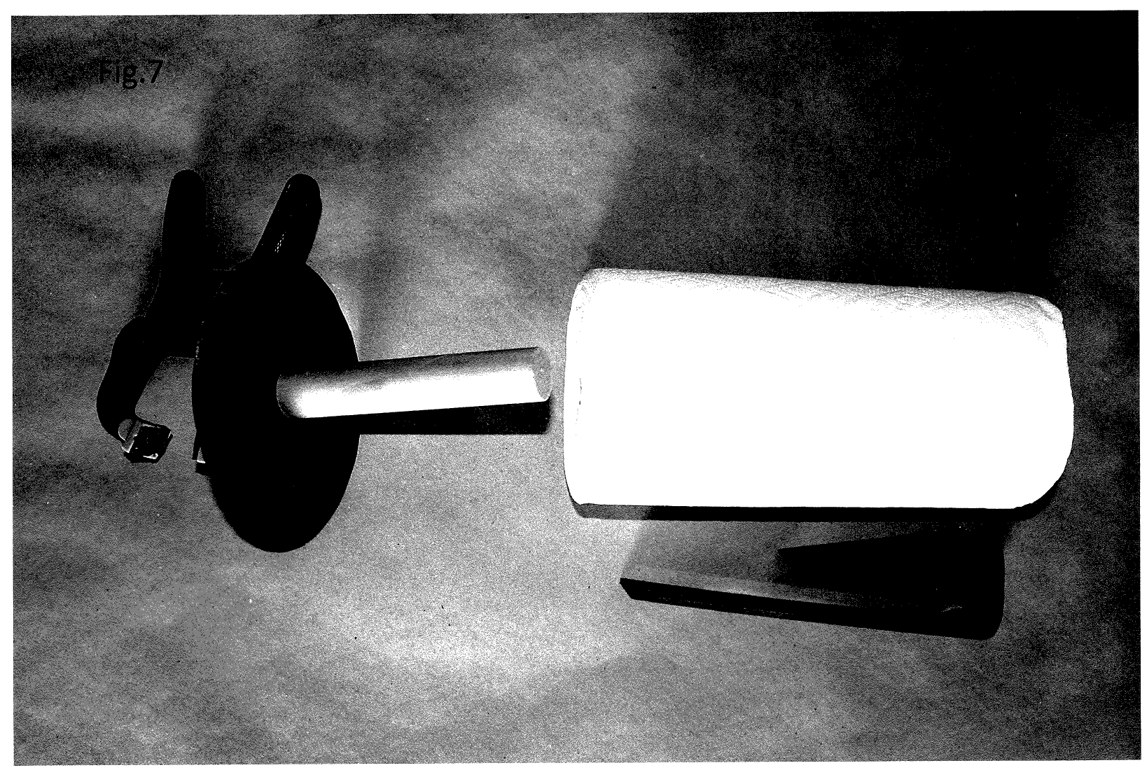

FIG. 7 Reddy for paper towel

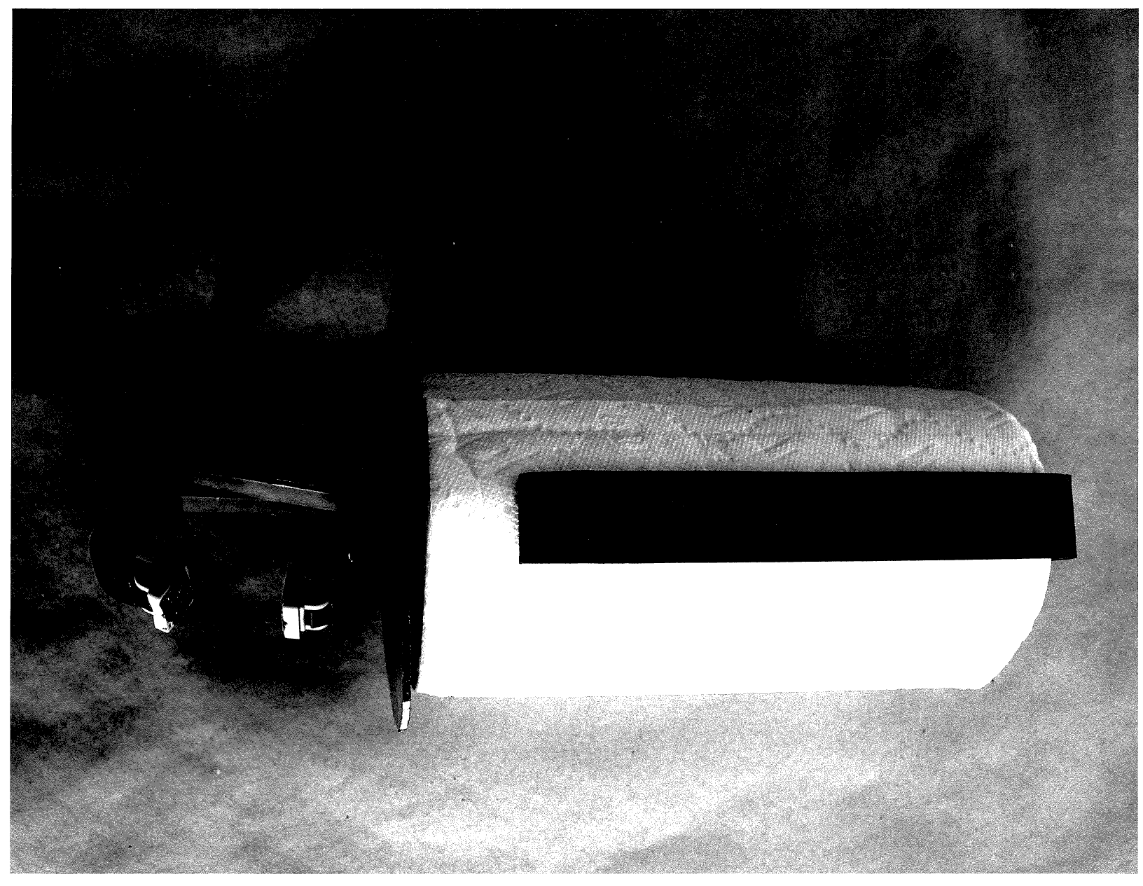

FIG. 8 Finished paper towel holder

### HOW THE INVENTION WORKS

Paper towels unroll and tear off

### HOW TO USE THE INVENTION

Clip anywhere and clean up mess

1. A clamp for securing paper towel holder almost any where indoors or outdoors comprising:
A first jaw and a second jaw relative to the first jaw and a handle operable to move the first jaw and the second jaw relative to each other to an approximate position.
